(19) United States
(12) Patent Application Publication
(10) Pub. No.: US 2018/0264723 A1
(43) Pub. Date: Sep. 20, 2018

(54) SHAPING DEVICE AND SHAPING METHOD

(71) Applicant: MIMAKI ENGINEERING CO., LTD., Nagano (JP)

(72) Inventors: Kazuhiro Ochi, NAGANO (JP); Masakazu Okajima, NAGANO (JP)

(73) Assignee: MIMAKI ENGINEERING CO., LTD., Nagano (JP)

(21) Appl. No.: 15/920,441

(22) Filed: Mar. 13, 2018

(30) Foreign Application Priority Data
Mar. 15, 2017 (JP) 2017-049496

(51) Int. Cl. B29C 64/209; B29C 64/112; B29C 64/393; B33Y 30/00; B33Y 50/02; B33Y 70/00

(52) U.S. Cl. CPC B29C 64/209; B29C 64/112; B29C 64/393; B33Y 10/00; B33Y 50/02; B33Y 70/00; B33Y 30/00

(57) ABSTRACT

A shaping device that shapes a stereoscopic three-dimensional object including a light reflecting material head, a plurality of coloring material heads, a clear material head, and a controller; where the three-dimensional object includes a light reflecting region and a coloring region; the coloring region includes an inner region and an outer region; and when a ratio of the coloring material with respect to a sum of materials for shaping used when forming each region of the coloring region is defined as a coloring material ratio, the controller causes the plurality of coloring material heads and the clear material head to eject the material for shaping so that the coloring material ratio in the outer region becomes greater than the coloring material ratio in the inner region.

### CROSS REFERENCE TO RELATED APPLICATIONS

This application claims the priority benefit of Japanese Patent Application No. 2017-049496, filed on Mar. 15, 2017. The entirety of the above-mentioned patent application is hereby incorporated by reference herein and made a part of this specification.

### TECHNICAL FIELD

The present disclosure relates to a shaping device and a shaping method.

### DESCRIPTION OF THE BACKGROUND ART

A shaping device (3D printer) for shaping a three-dimensional object using an inkjet head is conventionally known (e.g., Japanese Patent Application Laid-Open No. 2015-71282). In such a shaping device, for example, the three-dimensional object is shaped through a layering and shaping method by layering a plurality of layers of ink formed by the inkjet head.

Shaping a colored three-dimensional object by forming a surface of the three-dimensional object with a coloring ink (color ink) is recently being reviewed. In this case, for example, a light reflective region is formed with a white ink, and the like, and at a periphery thereof, a coloring region is formed with a coloring ink to represent various colors through a subtractive color mixing method.

### SUMMARY

When shaping the colored three-dimensional object, the coloring is desirably carried out through a method more suited for the configuration of the three-dimensional object to carry out coloring more appropriately at a high accuracy. More specifically, in this case, for example, it is considered to more appropriately carry out coloring with a desired color, and to carry out a broader range of coloring, and the like in view of the configuration of the three-dimensional object. Thus, conventionally, when shaping the colored three-dimensional object, it is desired to more appropriately carry out coloring, and the like. The present disclosure thus provides a shaping device and a shaping method capable of overcoming such problem.

The inventors of the present application carried out a thorough research on the method for more appropriately carrying out coloring, and the like when shaping a colored three-dimensional object. Consideration is made to carrying out coloring as described below in view of the configuration of the three-dimensional object.

In order to solve the problem described above, the present disclosure provides a shaping device that shapes a stereoscopic three-dimensional object, the shaping device including a light reflecting material head, which is an ejection head that ejects a material having light reflectiveness; a plurality of coloring material heads, which are a plurality of ejection heads that respectively eject a coloring material of a color different from each other; a clear material head, which is an ejection head that ejects a clear material or a translucent material that is not colored; and a controller that controls operations of the light reflecting material head, the plurality of coloring material heads, and the clear material head, where the three-dimensional object includes a light reflecting region, which is a region having light reflectiveness, formed using the material having light reflectiveness, and a coloring region, which is a region formed on an outer side than the light reflecting region using the coloring material and the clear material; the coloring region includes an inner region, which is a region closer to the light reflecting region, and an outer region, which is a region formed on the outer side than the inner region; and when a ratio of the coloring material with respect to a sum of materials for shaping used when forming each region of the coloring region is defined as a coloring material ratio, the controller causes the plurality of coloring material heads and the clear material head to eject the material for shaping so that the coloring material ratio in the outer region becomes greater than the coloring material ratio in the inner region.

According to such configuration, for example, when the three-dimensional object is observed, a position (depth) of the coloring material in the coloring region becomes a more uniform state that does not depend on the color. Furthermore, for example, the manner of reflecting light at the surface of the three-dimensional object, and the like can be appropriately prevented from differing depending on the color, and the like. Thus, according to such configuration, for example, when shaping the colored three-dimensional object, the coloring of the three-dimensional object can be more appropriately carried out.

Use of a shaping method having the features similar to above, and the like can be considered for the configuration of the present disclosure. In this case as well, for example, effects similar to above can be obtained. Furthermore, such a shaping method can be considered as a method for manufacturing the three-dimensional object. A configuration described in each claim of the Claims can also be considered for the configuration of the present disclosure. In such cases as well, when shaping the colored three-dimensional object, the coloring of the three-dimensional object can be more appropriately carried out.

According to the present disclosure, for example, when shaping the colored three-dimensional object, the coloring of the three-dimensional object can be more appropriately carried out.

### BRIEF DESCRIPTION OF THE DRAWINGS

FIGS. 1A to 1C are views showing one example of a shaping system 10 according to one embodiment of the present disclosure. FIG. 1A shows one example of a configuration of the shaping system 10. FIG. 1B shows one example of a configuration of a main part of a shaping device 12. FIG. 1C shows one example of a configuration of a head part 102.

FIGS. 2A and 2B are views describing a three-dimensional object 50 shaped by the shaping device 12 of the present example. FIG. 2A shows one example of a configuration of the three-dimensional object 50. FIG. 2B is a view showing one example of a configuration of a coloring region 156 in the present example.

FIGS. 3A to 3C are views describing a further variant of the manner of forming a light reflecting region 154. FIG. 3A is a view showing one example of a configuration of the light reflecting region 154 in the present example. FIG. 3B schematically shows a variant of the manner of coloring the light reflecting region 154. FIG. 3C schematically shows a further variant of the manner of coloring on the light reflecting region 154.

FIG. 4 shows a variant of a configuration of the head part 102 used when shaping the three-dimensional object 50.

FIGS. 5A to 5C are views showing one example of a configuration of the three-dimensional object 50 in the present variant. FIG. 5A shows one example of a configuration of the three-dimensional object 50 along with a support layer 52. FIG. 5B schematically shows one example of a configuration of a prism region 160. FIG. 5C shows a variant of a configuration of the prism region 160.

FIGS. 6A and 6B are views describing a variant of color conversion carried out in a control PC 14. FIG. 6A is a view describing one example of a gamut 502, which is a range of colors that can be represented when shaping the three-dimensional object 50 with the shaping device 12. FIG. 6B shows one example of a color conversion carried out in view of the saturation.

FIGS. 7A and 7B are views for making an explanation in relation to the shaping of a proof 70. FIG. 7A is a view showing one example of a configuration of the three-dimensional object 50 to shape as a final product; and FIG. 7B shows one example of a configuration of the proof 70 in which the three-dimensional object 50 shown in FIG. 7A is scale-reduced along with the support layer 52.

### DETAILED DESCRIPTION OF EMBODIMENTS

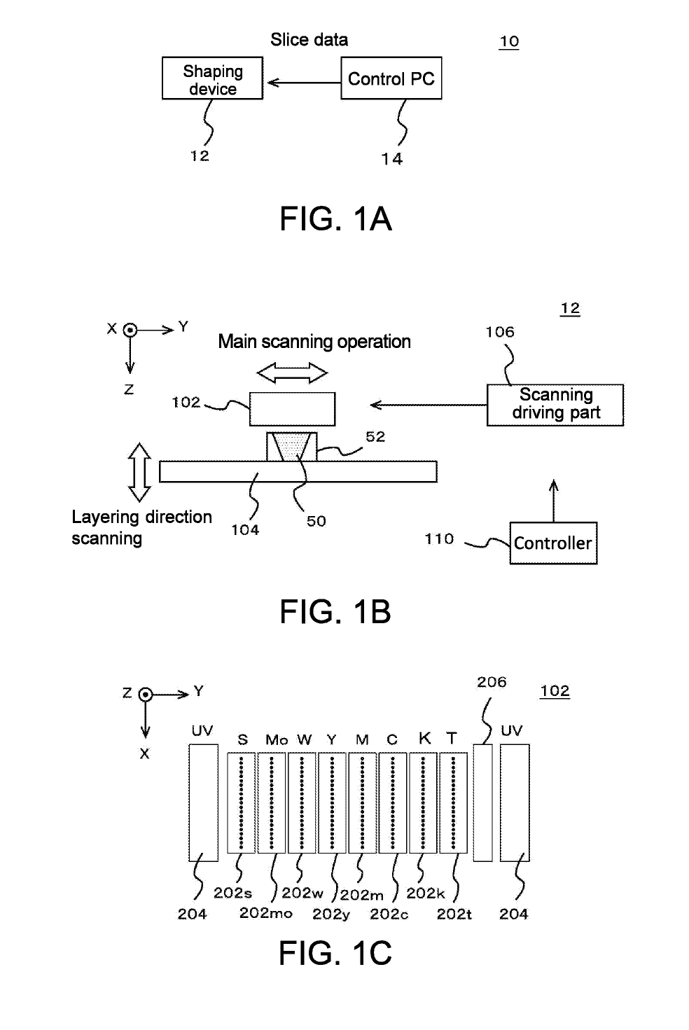

Hereinafter, an embodiment according to the present disclosure will be described with reference to the drawings. FIGS. 1A to 1C show one example of a shaping system 10 according to one embodiment of the present disclosure. FIG. 1 A shows one example of a configuration of the shaping system 10. In the present example, the shaping system 10 is a shaping system that shapes a stereoscopic three-dimensional object, and includes a shaping device 12 and a control PC 14.

The shaping device 12 is a device that executes the shaping of a three-dimensional object, and shapes the three-dimensional object according to the control of the control PC 14. More specifically, the shaping device 12 is a full color shaping device capable of shaping a three-dimensional object colored in full color, and receives data indicating the three-dimensional object to shape from the control PC 14 and shapes the three-dimensional object based on such data. Furthermore, in the present example, the shaping device 12 receives slice data indicating a cross-section of the three-dimensional object as the data indicating the three-dimensional object, and shapes the three-dimensional object based on the slice data.

The control PC 14 is a computer (host PC) that controls the operation of the shaping device 12. In the present example, the control PC 14 generates the slice data indicating the three-dimensional object to be shaped by the shaping device 12, and provides the slice data to the shaping device 12. The control PC 14 thereby controls the operation of shaping by the shaping device 12.

As described above, in the present example, the shaping system 10 is configured by the shaping device 12, and the control PC 14, or a plurality of devices. However, in a variant of the shaping system 10, the shaping system 10 may be configured by one device. In this case, for example, it is considered to configure the shaping system 10 with one shaping device 12 including the function of the control PC 14.

Next, a specific configuration of the shaping device 12 will be described. FIG. 1B shows one example of a configuration of a main part of the shaping device 12. In the present example, the shaping device 12 is a shaping device that shapes a stereoscopic three-dimensional object 50, and includes a head part 102, a shaping table 104, a scanning driving part 106, and a controller 110.

Other than the points described below, the shaping device 12 may have a configuration same as or similar to a known shaping device. More specifically, other than the points described below, the shaping device 12 may have a configuration same as or similar to, for example, a known shaping device that carries out shaping by ejecting a droplet to become the material of the three-dimensional object 50 using an inkjet head. Furthermore, other than the illustrated configuration, the shaping device 12 may also include, for example, various types of configurations necessary for shaping, coloring, and the like of the three-dimensional object 50. Moreover, in the present example, the shaping device 12 is a shaping device (3D printer) that shapes the stereoscopic three-dimensional object 50 through a layering and shaping method. In this case, the layering and shaping method is, for example, a method of shaping the three-dimensional object 50 by stacking a plurality of layers. The three-dimensional object 50 is, for example, a stereoscopic three-dimensional structural object.

The head part 102 is a portion that ejects the material of the three-dimensional object 50. Furthermore, in the present example, ink is used as the material of the three-dimensional object 50. In this case, the ink is, for example, liquid ejected from the inkjet head. More specifically, the head part 102 ejects ink, which cures according to a predetermined condition, from a plurality of inkjet heads as the material of the three-dimensional object 50. Each layer configuring the three-dimensional object 50 is formed in a stacking manner by curing the landed ink, thus shaping the three-dimensional object through the layering and shaping method. Furthermore, in the present example, ultraviolet curable ink (UV ink) that cures from the liquid state when irradiated with an ultraviolet light is used for the ink.

The head part 102 further ejects a material of a support layer 52, in addition to the material of the three-dimensional object 50. Furthermore, the shaping device 12 thereby forms the support layer 52, as necessary, at the periphery of the three-dimensional object 50. The support layer 52 is, for example, a layered structural object that surrounds the outer periphery of the three-dimensional object 50 being shaped to support the three-dimensional object 50. The support layer 52 is formed when shaping the three-dimensional object 50, as necessary, and removed after the shaping is completed.

The shaping table 104 is a table-like member that supports the three-dimensional object 50 being shaped, and is arranged at a position facing the inkjet head in the head part 102, where the three-dimensional object 50 being shaped is mounted on an upper surface. Furthermore, in the present example, the shaping table 104 has a configuration in which at least the upper surface is movable in a layering direction (Z direction in the figure), and moves at least the upper surface with the advancement of the shaping of the three-dimensional object 50 by being driven by the scanning driving part 106. In this case, the layering direction is, for example, a direction in which the material for shaping is layered in the layering and shaping method. More specifically, in the present example, the layering direction is a direction orthogonal to a main scanning direction (Y direction in the figure) and a sub-scanning direction (X direction in the figure).

The scanning driving part 106 is a driver that causes the head part 102 to carry out a scanning operation of relatively moving with respect to the three-dimensional object 50 being shaped. In this case, relatively moving with respect to the three-dimensional object 50 being shaped means, for example, relatively moving with respect to the shaping table 104. Furthermore, the head part 102 is caused to carry out the scanning operation means; for example, the inkjet head of the head part 102 is caused to carry out the scanning operation. Furthermore, in the present example, the scanning driving part 106 causes the head part 102 to carry out a main scanning operation (Y scanning), a sub-scanning operation (X scanning), and a layering direction scanning (Z scanning).

The main scanning operation is, for example, an operation of ejecting ink while moving in the main scanning direction. In the present example, the scanning driving part 106 causes the head part 102 to carry out the main scanning operation by fixing the position of the shaping table 104 in the main scanning direction and moving the head part 102. Moreover, the scanning driving part 106 may, for example, move the three-dimensional object 50 by fixing the position of the head part 102 in the main scanning direction and, for example, moving the shaping table 104.

The sub-scanning operation is, for example, an operation of relatively moving with respect to the shaping table 104 in a sub-scanning direction orthogonal to the main scanning direction. More specifically, the sub-scanning operation is, for example, an operation of relatively moving with respect to the shaping table 104 in the sub-scanning direction by a feeding amount set in advance. In the present example, the scanning driving part 106 causes the head part 102 to carry out the sub-scanning operation by fixing the position of the head part 102 in the sub-scanning direction and moving the shaping table 104 in between the main scanning operations. Furthermore, the scanning driving part 106 causes the head part 102 to carry out the sub-scanning operation by fixing the position of the shaping table 104 in the sub-scanning direction and moving the head part 102.

The layering direction scanning is, for example, an operation of relatively moving the head part 102 in the layering direction with respect to the three-dimensional object 50 by moving at least one of the head part 102 or the shaping table 104 in the layering direction. Furthermore, the scanning driving part 106 adjusts the relative position of the inkjet head with respect to the three-dimensional object 50 being shaped in the layering direction by causing the head part 102 to carry out the layering direction scanning with the advancement of the shaping operation. More specifically, in the present example, the scanning driving part 106 fixes the position of the head part 102 in the layering direction, and moves the shaping table 104. The scanning driving part 106 may fix the position of the shaping table 104 in the layering direction, and move the head part 102.

The controller 110 is, for example, a CPU of the shaping device 12, and controls the operation of shaping of the three-dimensional object 50 by controlling each part of the shaping device 12. Moreover, in the present example, the controller 110 controls each part of the shaping device 12 based on the slice data received from the control PC 14. In this case, the controller 110, for example, causes each inkjet head to eject the ink to use for the shaping of the three-dimensional object by controlling the operation of each inkjet head in the head part 102. According to the present example, the three-dimensional object 50 can be appropriately shaped.

Next, an example of a configuration of the head part 102 in the shaping device 12 and a configuration of the three-dimensional object 50 to be shaped by the shaping device 12 will be described in further detail. FIG. 1C shows one example of a configuration of the head part 102.

In the present example, the head part 102 includes a plurality of inkjet heads, a plurality of ultraviolet light sources 204, and a flattening roller 206. As shown in the figure, the plurality of inkjet heads include an inkjet head 202s, an inkjet head 202mo, an inkjet head 202w, an inkjet head 202y, an inkjet head 202m, an inkjet head 202c, an inkjet head 202k, and an inkjet head 202t. Such plurality of inkjet heads are, for example, arranged to be lined in the main scanning direction with the positions in the sub-scanning direction aligned. Furthermore, each inkjet head includes a nozzle row, in which a plurality of nozzles are lined in a predetermined nozzle row direction, on a surface facing the shaping table 104. Moreover, in the present example, the nozzle row direction is a direction parallel to the sub-scanning direction.

Among such inkjet heads, the inkjet head 202s is an inkjet head that ejects the material of the support layer 52. A known material for the support layer, for example, can be suitably used for the material of the support layer 52. The inkjet head 202mo is an inkjet head that ejects a shaping material ink (Mo ink). In this case, for example, the shaping material ink is an ink dedicated to shaping used for the shaping of the interior (interior region) of the three-dimensional object 50.

The interior of the three-dimensional object 50 is not limited to being formed with the shaping material ink, and may be formed by further using an ink of another color. For example, it is considered to form the interior of the three-dimensional object 50 without using the shaping material ink and by using only the ink of another color (e.g., white ink, etc.). In this case, the inkjet head 202mo may be omitted in the head part 102. Furthermore, the interior of the three-dimensional object 50 is not limited to being formed with such inks, and for example, an arbitrary ink other than the material may be used to form the support layer 52.

The inkjet head 202w is an inkjet head that ejects white (W) ink. In the present example, the white ink is one example of an ink having light reflectiveness, and is used, for example, when forming a region (light reflecting region) having a property of reflecting light in the three-dimensional object 50. Furthermore, the inkjet head 202w is one example of a light reflecting material head.

The inkjet head 202y, the inkjet head 202m, the inkjet head 202c, and the inkjet head 202k (hereinafter referred to as inkjet heads 202y to 202k) are inkjet heads for coloring used at the time of shaping of the colored three-dimensional object 50. More specifically, the inkjet head 202y ejects yellow (Y) ink. The inkjet head 202m ejects magenta (M) ink. The inkjet head 202c ejects cyan (C) ink. The inkjet head 202k ejects black (K) ink.

In the present example, each color of YMCK is one example of a process color used in full color representation by the subtractive color mixing method. The ink of each color is one example of the material for coloring. In this case, the material for coloring is, for example, a colored material used for the coloring of the three-dimensional object 50. The inkjet heads 202y to 202k are examples of a plurality of coloring material heads.

The inkjet head 202t is an inkjet head that ejects a clear ink. The clear ink is, for example, a colorless transparent (T) clear ink. In the present example, the clear ink is one example of a clear material, which is a translucent material that is not colored. The inkjet head 202t is one example of a clear material head.

The plurality of ultraviolet light sources 204 are light sources (UV light sources) for curing the ink, and generates an ultraviolet light for curing the ultraviolet curable ink. Furthermore, in the present example, each of the plurality of ultraviolet light sources 204 is disposed at one end side and the other end side in the main scanning direction in the head part 102 so as to sandwich the arrangement of the inkjet heads in between UVLED (ultraviolet LED), and the like, for example, can be suitably used for the ultraviolet light source 204. Furthermore, it is also considered to use metal halide lamp, mercury lamp, and the like for the ultraviolet light source 204.

The flattening roller 206 is a flattening means for flattening the layer of ink formed during the shaping of the three-dimensional object 50. The flattening roller 206 is, for example, brought into contact with the surface of the layer of ink during the main scanning operation to remove some of the ink before being cured, thus flattening the layer of ink.

The layer of ink configuring the three-dimensional object 50 can be appropriately formed by using the head part 102 having the configuration described above. Furthermore, the three-dimensional object 50 can be appropriately shaped by forming the plurality of layers of ink in a stacking manner.

The specific configuration of the head part 102 is not limited to the configuration described above, and may be variously modified. For example, the head part 102 may further include an inkjet head for colors other than the above for the inkjet head for coloring. Moreover, the manner of arranging the plurality of inkjet heads in the head part 102 can be variously modified. For example, some inkjet heads may have the positions shifted in the sub-scanning direction with respect to the other inkjet heads.

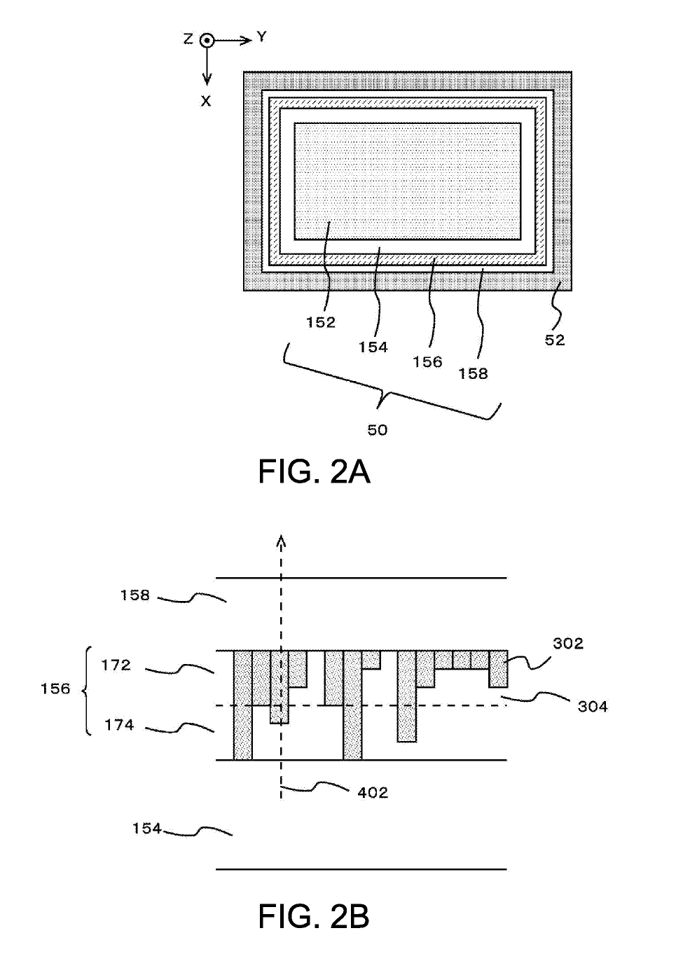

Next, a configuration of the three-dimensional object 50 shaped by the shaping device 12 of the present example will be described in further detail. FIGS. 2A and 2B are views describing the three-dimensional object 50 shaped by the shaping device 12 of the present example. FIG. 2A is a view showing one example of a configuration of the three-dimensional object 50, and shows one example of the configuration at the X-Y cross-section, which is a cross-section of the three-dimensional object 50 orthogonal to the layering direction (Z direction), along with the support layer 52. In this case, the configurations of the Z-X cross-section and the Z-Y cross-section of the three-dimensional object 50 perpendicular to the Y direction and the Z direction also have a similar configuration.

As described above, in the present example, the shaping device 12 (see FIGS. 1A to 1C) shapes the colored three-dimensional object 50 using the inkjet heads 202y to 202k (see FIG. 1C). In this case, the colored three-dimensional object 50 is, for example, the three-dimensional object 50 in which at least the surface is colored. When referring to the surface of the three-dimensional object 50 being colored, this means, for example, that at least one part of a region where the hue can be visually recognized from the outside in the three-dimensional object 50 is colored. More specifically, in the present example, the shaping device 12 shapes the three-dimensional object 50 including, for example, an interior region 152, a light reflecting region 154, a coloring region 156, and a protective region 158, as shown in the figure. Furthermore, the support layer 52 is formed at the periphery of the three-dimensional object 50, and the like, as necessary.

The interior region 152 is a region configuring the interior of the three-dimensional object 50. The interior region 152 can be considered as, for example, a region configuring the shape of the three-dimensional object 50. In the present example, the shaping device 12 forms the interior region 152 using the shaping material ink ejected from the inkjet head 202mo (see FIG. 1C).

The light reflecting region 154 is a region having light reflectiveness for reflecting the light incident from the outside of the three-dimensional object 50 through the coloring region 156, and the like. In the present example, the shaping device 12 shapes the light reflecting region 154 at the periphery of the interior region 152 using the white ink ejected from the inkjet head 202w (see FIG. 1C).

The coloring region 156 is a region colored by the coloring ink ejected from the inkjet heads 202y to 202k. In the present example, the shaping device 12 forms the coloring region 156 at the periphery of the light reflecting region 154 using the coloring ink ejected from the inkjet heads 202y to 202k, and the clear ink ejected from the inkjet head 202t (see FIG. 1C). Thus, the coloring region 156 is formed on the outer side of the light reflecting region 154 in the three-dimensional object 50. Furthermore, in this case, for example, various colors are represented by adjusting the ejecting amount of the coloring ink of each color to each position. The clear ink is used to compensate the change in the amount of coloring ink (ejecting amount per unit volume is 0% to 100%) caused by the difference in color to a constant 100%. According to such configuration, for example, each position of the coloring region 156 can be appropriately colored with a desired color.

The protective region 158 is a transparent region for protecting the outer surface of the three-dimensional object 50. Furthermore, in the present example, the protective region 158 is one example of an outer clear region. The shaping device 12 forms the protective region 158 at the periphery of the coloring region 156 using the clear ink ejected from the inkjet head 202t (see FIG. 1C). According to such configuration, for example, the protective region 158 can be appropriately formed so as to cover the outer side of the coloring region 156 using the transparent material. Furthermore, according to the present example, the three-dimensional object 50 whose surface is colored can be appropriately formed by forming each region in the above manner.

In a variant of the configuration of the three-dimensional object 50, it is considered to make a specific configuration of the three-dimensional object 50 different from the above. In this case, for example, it is considered to form the interior region 152 also having the function of the light reflecting region 154 using the white ink, and the like without distinguishing the interior region 152 and the light reflecting region 154. Furthermore, it is also considered to omit some regions in the three-dimensional object 50, and the like. In this case, for example, it is considered to omit the protective region 158. Moreover, it is considered to further form a region other than the above, and the like in the three-dimensional object 50. In this case, for example, it is considered to form a separation region between the light reflecting region 154 and the coloring region 156, and the like. The separation region is, for example, a transparent region (transparent layer) for preventing the ink configuring the light reflecting region 154 and the ink configuring the coloring region 156 from mixing. In this case, the shaping device 12, for example, shapes the separation region at the periphery of the light reflecting region 154 using the clear ink ejected from the inkjet head 202t.

Next, a manner of forming the coloring region 156 in the present example will be described in further detail. FIG. 2B is a view showing one example of a configuration of the coloring region 156 in the present example, and schematically shows one example of the configuration of the coloring region 156 along with the light reflecting region 154 and the protective region 158.

As described above, in the present example, the shaping device 12 shapes the three-dimensional object 50 based on the slice data received from the control PC 14 (see FIG. 1A). In this case, the layer of respective ink configuring the three-dimensional object 50 is formed based on the slice data indicating the cross-section of each position. Furthermore, in this case, the slice data indicates the configuration including the portion corresponding to each region shown in FIG. 2A as a configuration of the cross-section of each position.

As described above, in the present example, the coloring region 156 of the three-dimensional object 50 is formed using the ink of each color of YMCK, which are coloring inks ejected from the inkjet heads 202y to 202k, and the clear ink. In this case, the position to eject the ink of each color in the coloring region 156 is specified by the slice data. Furthermore, in the present example, the three-dimensional object 50 is more appropriately colored not only by just adjusting the ejecting amount of the clear ink in the coloring region 156, but also by adjusting the position and the like to eject the ink of each color in the coloring region 156.

More specifically, in the present example, the shaping device 12 ejects the ink of each color of YMCK and the clear ink with respect to the respective ejecting position (voxel position) determined according to a resolution of shaping in the coloring region 156 in accordance with the color for coloring the surface of the three-dimensional object 50. Furthermore, the coloring region 156 including a coloring portion 302 and a transparent portion 304 is thereby formed. In this case, the coloring portion 302 is a portion formed with the coloring ink (ink of each color of YMCK) in the coloring region 156. The transparent portion 304 is a portion formed by the clear ink in the coloring region 156.

In the present example, a distribution of the coloring portion 302 and the transparent portion 304 in the coloring region 156 is set such that at least the coloring portion 302 is greater in the outer region 172 in the coloring region 156 and the transparent portion 304 is greater in an inner region 174 in the coloring region 156, as shown in the figure. In this case, the outer region 172 in the coloring region 156 is a region close to the outer side of the three-dimensional object 50 in the coloring region 156. Furthermore, the outer region 172 can be considered as, for example, a region closer to the protective region 158 in the coloring region 156. Moreover, the outer region 172 can be considered as, for example, a region formed on the outer side of the inner region 174 in the coloring region 156, and the like. The inner region 174 in the coloring region 156 is a region close to the inner side of the three-dimensional object 50 in the coloring region 156. Furthermore, the inner region 174 can be considered as, for example, a region closer to the light reflecting region 154 in the coloring region 156.

In the present example, the outer region 172 and the inner region 174 are not regions distinctly divided in the light reflecting region 154, and are regions to which the coloring region 156 is divided for the sake of convenience. The boundary of the outer region 172 and the inner region 174 can be considered as, for example, separating the thickness of the coloring region 156 in half.

Furthermore, the distribution of the coloring portion 302 in the coloring region 156 is set, more specifically, for example, so that the coloring portion 302 is lined with the surface (outermost surface) of the coloring region 156, as shown in the figure. In this case, the surface of the coloring region 156 is the surface on the outermost side in the coloring region 156. In this case, for example, the coloring portion 302 and the transparent portion 304 are lined such that the coloring portion 302 is on the outer side and the transparent portion 304 is on the inner side in a normal direction of the three-dimensional object 50, as shown with an arrow 402 in the figure. In this case, the normal direction of the three-dimensional object 50 is a direction orthogonal to the surface of the three-dimensional object 50 at each position of the surface of the three-dimensional object 50.

When carrying out coloring with various colors with respect to the three-dimensional object 50, the amount of coloring ink to be ejected with respect to each position of the light reflecting region 154 differs depending on the position. Thus, when considering the length in the normal direction for the coloring portion 302 formed at each position of the coloring region 156, a difference arises in the length depending on the position of the coloring region 156. In this case, for example, if only the coloring portion 302 is merely formed in the coloring region 156 taking into consideration only the hue of the color and the density of the color for coloring on each position of the coloring region 156, the transparent portion 304 may sometimes form between the surface of the coloring region 156 and the coloring portion 302. Furthermore, in this case, the length of the transparent portion 304 sandwiched between the surface and the coloring portion 302 is assumed to variously change due to the difference in the hue of the color, the density of the color, and the like for coloring on each position of the coloring region 156.

However, in this case, the distance (depth) from the surface of the three-dimensional object 50 to the coloring portion 302 changes by the position in the coloring region 156, which may influence the way the surface of the three-dimensional object 50 is seen. More specifically, for example, in such a case, the reflecting manner of light at each position on the surface of the three-dimensional object 50 becomes non-uniformed, which may influence the way the surface of the three-dimensional object 50 is seen. Furthermore, in this case, for example, the color may become dull as an extra transparent portion 304 is formed on the outer side of the coloring portion 302. Moreover, the clearness of color development may be affected due to the influence of refraction, absorption, and the like of the light by the extra transparent portion 304.

On the contrary, in the present example, the distance (depth) from the surface of the three-dimensional object 50 to the coloring portion 302 can be more appropriately made uniform by forming the coloring region 156 such that the coloring portion 302 is lined with the surface of the coloring region 156. Thus, for example, with respect to the coloring portion 302 formed on the surface side of the coloring region 156, the difference (irregularities) in the depth caused by the difference in hue and density of the color for coloring can be appropriately reduced and the reflecting manner of light at each position on the surface of the three-dimensional object 50 can be uniformized. The dullness, and the like of the color can be suppressed and the coloring with a bright color can be more appropriately carried out by preventing the extra transparent portion 304 from being formed on the outer side of the coloring portion 302, and the like.

The configuration of the present example, for example, can also be considered as a configuration of aligning the position (depth) of the coloring portion 302 on the surface side of the coloring region 156 by forming the coloring region 156 such that the coloring portion 302 is lined with the surface of the coloring region 156, and then making different the position (depth) of the coloring portion 302 closer to the light reflecting region 154 according to the hue and the density, and the like. In this case, the position of the coloring portion 302 in the surface of the coloring region 156 is the position (height) of the portion on the outermost side in the coloring portion 302. Furthermore, the position of the coloring portion 302 closer to the light reflecting region 154 is the position of the portion on the innermost side in the coloring portion 302.

With regards to the configuration of the present example, when a ratio of the amount of the coloring ink with respect to the sum of the amount of the inks used in the respective formation of the outer region 172 and the inner region 174 is defined as a coloring material ratio, a configuration of having the coloring material ratio in the outer region 172 greater than the coloring material ratio in the inner region 174, and the like can be considered. In this case, the sum of the amount of the inks used in the respective formation of the outer region 172 and the inner region 174 is, for example, the sum of the amount of ink (YMCK ink) of each color of YMCK and the amount of clear ink used at the time of forming each region. Furthermore, the coloring material ratio can also be considered as, for example, a proportion of the amount of YMCK ink in each region. In this case, the arrangement of the coloring portion 302 and the transparent portion 304 described above can be considered as, for example, an arrangement in which the transparent portion 304 formed by the clear ink is on the inner side and the coloring portion 302 formed by the coloring ink is on the outer side on a straight line from the light reflecting region 154 toward the outer side of the three-dimensional object 50, and the like.

Furthermore, in the configuration of the present example, the coloring portion 302 in the coloring region 156 is sandwiched between the transparent portion 304 in the coloring region 156 and the protective region 158. Thus, for such configuration, for example, the coloring portion 302 in the coloring region 156 can be considered to have a configuration of being sandwiched by the transparent region formed with the clear ink, and the like. In this case, the reflecting manner of light at each position on the surface of the three-dimensional object 50 can be more appropriately uniformed by forming the transparent protective region 158 on the outer side of the coloring portion 302. Thus, according to the present example, for example, the clear coloring can be more appropriately carried out with respect to the three-dimensional object 50. In this case, a depth feeling can be expressed in the colored state, and the like, for example, by forming the protective region 158 on the outer side of the coloring portion 302.

Thus, in the present example, the clear coloring is realized by adjusting the manner of forming the coloring portion 302 and the transparent portion 304 in the coloring region 156. Furthermore, in a variant of the configuration of the shaping system 10 (see FIGS. 1A to 1C), it is also considered to carry out clear coloring, a broader range of coloring, and the like through other methods. Various variants of the configuration of the three-dimensional object 50 shaped by the shaping system 10 will be described below. In each variant described below, the coloring region 156 is not necessarily formed like the configuration shown in FIG. 2B, and may be formed same as or similar to the coloring region in a known three-dimensional object. Furthermore, the coloring region 156 may be formed same as or similar to the configuration shown in FIG. 2B.

First, a variant will be described for a manner of forming the light reflecting region 154. A case of forming the light reflecting region 154 in the three-dimensional object 50 using the white ink has been described above. However, the light reflecting region 154 is not limited to being formed with the white ink, and may be formed with the ink having light reflectiveness of other colors. In this case, for example, it is considered to use an ink that reflects light more easily than the white ink. According to such configuration, for example, the light reflecting region 154 having a higher reflectiveness can be formed. Furthermore, in this case, the absorption of light that occurs in the three-dimensional object 50 can be reduced and a clearer color representation can be realized, for example, by forming the light reflecting region 154 of high reflectiveness as a layer to become a base of the coloring region 156. Furthermore, the color development property and the color reproduction property can be appropriately enhanced for the color represented by the coloring region 156.

In this case, it is considered to form the light reflecting region 154 to a region of high reflectiveness such as a mirror surface, for example. Consideration is also made to use an ink having glossiness, for example, for the ink for forming such light reflecting region 154. In this case, the ink having glossiness is one example of a material having glossiness. Furthermore, in this case, the head part 102 (see FIG. 1B) in the shaping device 12 includes an inkjet head for glossy ink in place of the inkjet head 202w (see FIG. 1C) as the light reflecting material head. Moreover, the head part 102 may further include the inkjet head for glossy ink in addition to the inkjet head 202w.

Furthermore, in this case, an ink containing a glossy pigment, and the like, for example, can be used for the glossy ink. More specifically, it is considered to use, for example, an ink having a metallic color containing a metallic pigment such as a metal piece, and the like, an ink containing a glass bead element having a property of reflecting light as the pigment, and the like for the ink.

Moreover, in this case, it is considered not to merely improve the reflectiveness of the light reflecting region 154 by using the metallic ink, and the like, but to form the colored light reflecting region 154 having high reflectiveness by further using the coloring ink (ink of each color of YMCK). In this case, when forming the light reflecting region 154, the colored light reflecting region 154 having glossiness is formed by causing the inkjet heads 202y to 202k (see FIG. 1C) to eject the coloring ink, and causing the inkjet head used for the light reflecting material head to eject the glossy ink such as the metallic ink, and the like.

More specifically, in this case, it is considered to combine a colorless metallic ink such as silver and the YMCK ink to form the light reflecting region 154 with the glossy color of various colors such as gold. Furthermore, in this case, the color visually recognized from the outside of the three-dimensional object 50 is a synthetic color of the color of the light reflecting region 154 such as gold and the color of the coloring region 156. Thus, according to such configuration, for example, a broader range of coloring can be carried out with respect to the three-dimensional object 50. Moreover, in this case, the coloring on the light reflecting region 154 carried out using the YMCK ink may be, for example, coloring on one part of the light reflecting region 154. The color for coloring on the light reflecting region 154 may be differed depending on the position of the light reflecting region 154.

Furthermore, in a further variant of the manner of forming the light reflecting region 154, for example, it is considered to carry out coloring on the light reflecting region 154, and the like by further using the YMCK ink when forming the light reflecting region 154 using the white ink. In this case, for example, the coloring may be carried out using the YMCK ink on at least one part of a region on the coloring region 156 side in the light reflecting region 154.

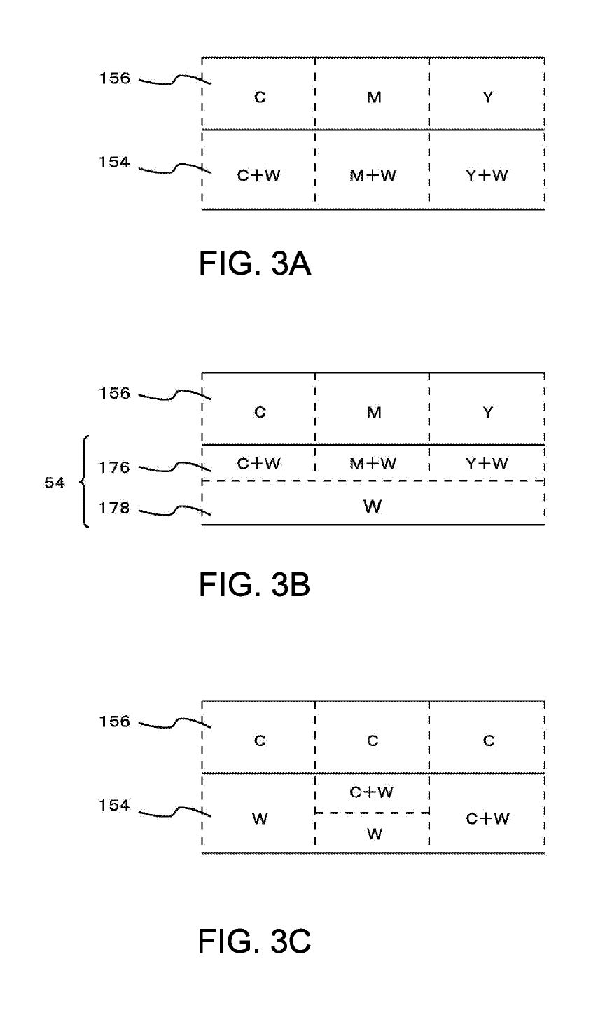

FIGS. 3A to 3C are views describing a further variant of the manner of forming the light reflecting region 154. FIG. 3A is a view showing one example of a configuration of the light reflecting region 154 in the present variant, and schematically shows one example of the configuration of the light reflecting region 154 along with the coloring region 156. Other than the points described below, in FIGS. 3A to 3C, the configuration denoted with the same reference number as FIGS. 1A to 1C, 2A and 2B may have the same or similar feature as the configuration in FIGS. 1 A to 1C, 2A and 2B.

In the present variant, when forming the light reflecting region 154, the light reflecting region 154 in which at least one part is colored with the coloring ink is formed by causing the inkjet head 202w (see FIG. 1C) to eject the white ink, and causing the inkjet heads 202y to 202k (see FIG. 1C) to eject the coloring ink. In this case, for example, it is considered to color each position of the light reflecting region 154 in accordance with the color for coloring in the coloring region 156, so that a color darker than when representing the color with only the coloring region 156 can be represented.

More specifically, in this case, the controller 110 (see FIG. 1B) in the shaping device 12 causes the inkjet heads 202y to 202k to eject ink with respect to at least one part of the light reflecting region 154. In this case, causing the inkjet heads 202y to 202k to eject the ink means, for example, causing at least one of the inkjet heads 202y to 202k to eject the ink in accordance with the color for coloring. Furthermore, in this case, rather than representing the desired color with only the coloring region 156, the color represented by overlapping the coloring region 156 and the light reflecting region 154 matches the color to be colored on the three-dimensional object 50. According to such configuration, for example, with respect to the color for coloring on the three-dimensional object 50, the color development property can be further enhanced and a clear color can be more appropriately represented.

More specifically, in the case shown in FIG. 3A, the position of respective positions of the light reflecting region 154 that overlaps a portion of the coloring region 156 colored to the C color is colored to the C color using the white (W) ink and the C ink. Furthermore, the position that overlaps a portion of the coloring region 156 colored to the M color is colored to the M color using the white ink and the M ink. The position that overlaps a portion of the coloring region 156 colored to the Y color is colored to the Y color using the white ink and the Y ink.

In this case, a dark color, and the like can be appropriately represented even when the thickness of the coloring region 156 is made thin, for example, by carrying out the coloring also on the light reflecting region 154. Thus, according to the present variant, for example, the thickness of the coloring region 156 can be appropriately reduced. Thus, for example, dullness and the like of the color caused by the influence of the clear ink in the coloring region 156 can be appropriately prevented from occurring. Therefore, according to the present variant, with regards to such an aspect as well, a clearer coloring can be carried out with respect to the three-dimensional object 50.

As described above, in the shaping system 10, for example, the slice data is generated in the control PC 14 (see FIG. 1A). In this case, for example, processes such as color conversion are carried out in accordance with the color of the ink to use for the shaping, and the like. More specifically, in this case, the slice data is generated based on the 3D data of a general format. Furthermore, the color conversion to a CMYK color coordinate system is carried out for the color represented with the RGB color coordinate system in the 3D data. When carrying out coloring with respect to the light reflecting region 154 as well as in the present variant, it is considered to carry out processes such as color conversion in view of the coloring carried out with respect to the light reflecting region 154 at the time of generating the slice data in the control PC 14. According to such configuration, for example, the surface of the three-dimensional object 50 can be appropriately colored by the light reflecting region 154 and the coloring region 156.

Furthermore, when carrying out coloring on the light reflecting region 154 as in the present variant, the coloring on the light reflecting region 154 is not necessarily carried out on the entire light reflecting region 154, and may be carried out on only one part of the light reflecting region 154. In this case, it is considered to carry out coloring adapted to the color of the surface only with respect to the region of the light reflecting region 154 corresponding to the portion to carry out coloring of a dark color with respect to the surface of the three-dimensional object 50. The portion to carry out the coloring of a dark color is, for example, a portion where the density of the color to be colored on the surface of the three-dimensional object 50 is darker than the density set in advance. When configured in such a manner, for example, a wider range can be appropriately represented for the range of representable colors by coloring the light reflecting region 154 as necessary. Thus, for example, a broader range of coloring on the three-dimensional object 50 can be more appropriately realized.

Consideration is also made to further make various changes on the manner of coloring the light reflecting region 154. FIG. 3B schematically shows a variant of the manner of coloring the light reflecting region 154. In this case, with respect to the coloring on the light reflecting region 154, the coloring is carried out only with respect to the region on the coloring region 156 side in the light reflecting region 154.

More specifically, in the illustrated configuration, the light reflecting region 154 includes a color reflecting region 176 and a white reflecting region 178. The color reflecting region 176 is a region on the coloring region 156 side in the light reflecting region 154, and is formed in a colored state by further using a coloring ink other than the white ink, same as or similar to the light reflecting region 154 shown in FIG. 3A. Furthermore, the white reflecting region 178 is a region on a side distant from the coloring region 156 in the light reflecting region 154, and is formed with the white ink without using the coloring ink at a position sandwiching the color reflecting region 176 with the coloring region 156.

When configured in such a manner as well, for example, the coloring on the light reflecting region 154 can be appropriately carried out. Furthermore, for example, with respect to the color for coloring on the three-dimensional object 50, the color development property can be further enhanced and a clear color can be more appropriately represented. Furthermore, in this case as well, the coloring on the color reflecting region 176 in the light reflecting region 154 may be carried out on only one part of the color reflecting region 176 according to, for example, the density, and the like of the color for coloring the surface of the three-dimensional object 50.

In a further variant of the manner of coloring on the light reflecting region 154, for example, the manner of coloring may be differed depending on the position in the light reflecting region 154. FIG. 3C schematically shows a further variant of the manner of coloring on the light reflecting region 154.

In this case, for example, it is considered to carry out coloring same as or similar to the case shown in FIG. 3A as in a region on a right side in the light reflecting region 154 in the figure, for example, with respect to one part of the light reflecting region 154, and carry out coloring same as or similar to the case shown in FIG. 3B as in a region in the middle in the light reflecting region 154 in the figure, for example, with respect to another part of the light reflecting region 154. In this case as well, another further part of the light reflecting region 154 may not be performed with coloring, and may be formed with only the white ink as in, for example, the region on the left side in the light reflecting region 154 in the figure. When configured in such a manner as well, for example, the coloring on the light reflecting region 154 can be appropriately carried out. Furthermore, for example, with respect to the color for coloring on the three-dimensional object 50, the color development property can be further enhanced and a clear color can be more appropriately represented.

From the standpoint of carrying out a broader range of coloring with respect to the three-dimensional object 50, in the variant of the configuration of the three-dimensional object 50, for example, it is also considered to further form a translucent region, and the like that performs various optical actions on the light reflected by the light reflecting region 154. Furthermore, in this case, for example, it is considered to combine a plurality of types of clear ink having different optical properties to form such a region.

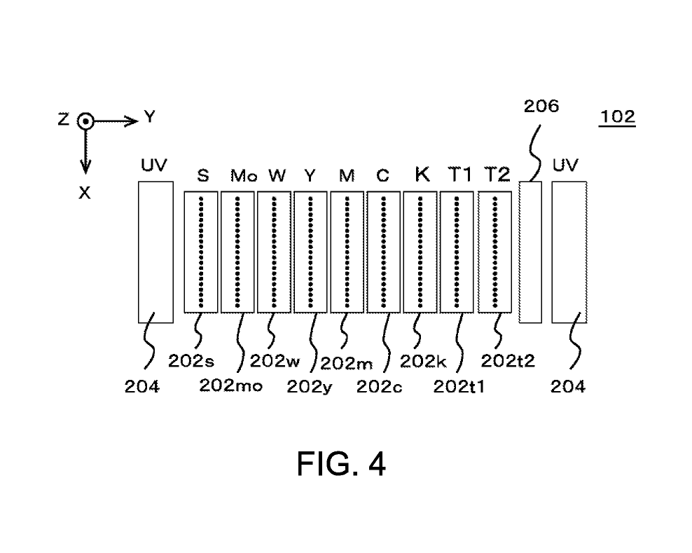

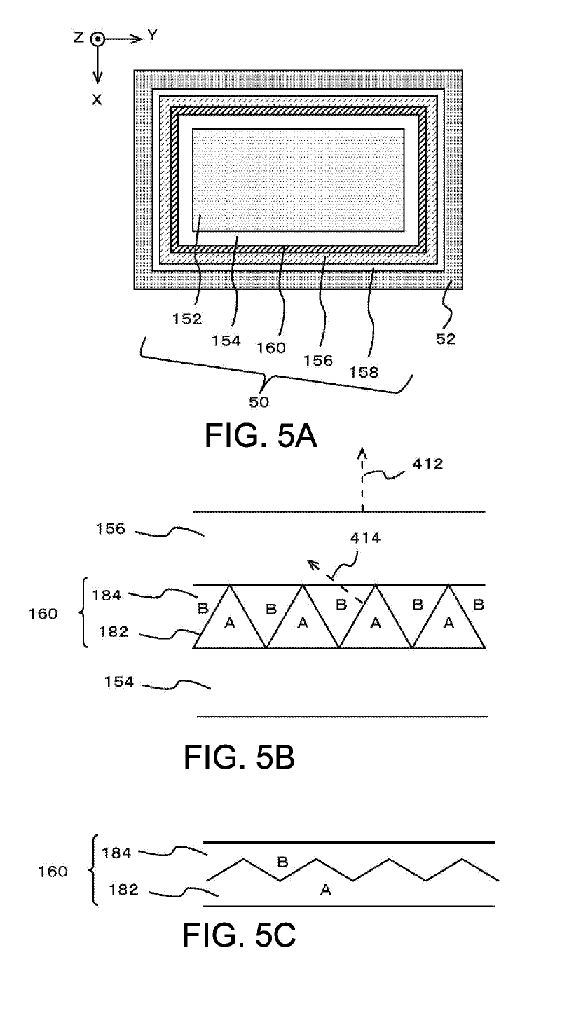

FIGS. 4 and 5A to 5C are views describing a variant of the configuration of the three-dimensional object 50. In the present variant, for example, the three-dimensional object 50 is shaped using the shaping device 12 (see FIGS. 1A and 1B) including the head part 102 having a configuration in which one part is different from the case shown in FIG. 1B. In this case, with regards to the points other than those described below, for example, the three-dimensional object 50 is shaped through operations same as or similar to the case described using FIGS. 1A to 1C, 2A, 2B and 3A to 3C. Furthermore, other than the points described below, in the figures after FIG. 4, the configuration denoted with the same reference number as FIGS. 1A to 1C, 2A, 2B and 3A to 3C may have the same or similar feature as the configuration in FIGS. 1A to 1C, 2A, 2B and 3A to 3C.

FIG. 4 shows one example of a configuration of the head part 102 used when shaping the three-dimensional object 50 of the present variant. In the present variant, the head part 102 includes an inkjet head 202t1 and an inkjet head 202t2, which are a plurality of inkjet heads, for the inkjet head for clear ink. Each of the inkjet head 202t1 and the inkjet head 202t2 is one example of the clear material head, and ejects a clear ink having different transmission characteristics with respect to light from each other. More specifically, in the present variant, each of the inkjet head 202t1 and the inkjet head 202t2 ejects a clear ink having different index of refraction with respect to light (visible light) from each other. In this case, the clear ink ejected from the inkjet head 202t1 is one example of a first clear material. The clear ink ejected from the inkjet head 202t2 is one example of a second clear material.

FIGS. 5A to 5C are views showing one example of a configuration of the three-dimensional object 50 in the present variant. FIG. 5A shows one example of a configuration of an X-Y cross-section of the three-dimensional object 50 along with the support layer 52. In the present variant, the shaping device 12 shapes the three-dimensional object 50 including the interior region 152, the light reflecting region 154, a prism region 160, the coloring region 156, and the protective region 158 for the three-dimensional object 50. Furthermore, the support layer 52 is formed at the periphery of the three-dimensional object 50, as necessary.

Of the regions in the three-dimensional object 50, the interior region 152, the light reflecting region 154, the coloring region 156, and the protective region 158 are regions same as or similar to each region of the three-dimensional object 50 shown in FIG. 2A. Furthermore, in the present variant, the prism region 160 in the three-dimensional object 50 is one example of a translucent region, which is a region formed on the outer side than the light reflecting region 154 using a plurality of types of clear ink ejected from each of the inkjet head 202t1 and the inkjet head 202t2, and is formed between the light reflecting region 154 and the coloring region 156.

FIG. 5B schematically shows one example of a configuration of the prism region 160. In the present variant, the prism region 160 includes a first clear region 182 and a second clear region 184. The first clear region 182 is a region shown with a reference symbol A in the figure, and is formed with the clear ink ejected from the inkjet head 202t1. The second clear region 184 is a region shown with a reference symbol B in the figure, and is formed with the clear ink ejected from the inkjet head 202t2.

As shown in the figure, the first clear region 182 is formed on the light reflecting region 154 side in the prism region 160. The second clear region 184 is formed on the outer side of the first clear region 182 while making contact with the first clear region 182. Furthermore, in the present variant, the first clear region 182 and the second clear region 184 are formed with the clear ink of a type different from each other to become translucent regions having an index of refraction different from each other.

Furthermore, a boundary surface between the first clear region 182 and the second clear region 184 is a surface that changes in a wavelike form, as shown in the figure. In this case, when referring to the boundary surface changing in a wavelike form, for example, this means that the distance from the surface of the three-dimensional object 50 changes depending on the position. As a result, a normal direction of the boundary surface is non-parallel to the normal direction of the surface of the three-dimensional object 50 on the outer side of the boundary surface. In this case, the normal direction of the boundary surface is, for example, a direction orthogonal to the boundary surface between the first clear region 182 and the second clear region 184, as shown with an arrow 414 in the figure. Furthermore, the normal direction of the surface of the three-dimensional object 50 is a direction orthogonal to the surface of the three-dimensional object 50. Moreover, in the case of the three-dimensional object 50 configured as shown in FIG. 5A, the normal direction of the surface of the three-dimensional object 50 is a direction orthogonal to the surface on the outer side of the protective region 158. This direction is substantially the same as, for example, the direction orthogonal to the surface of the coloring region 156, as shown with an arrow 412 in the figure.

When referring to the normal direction of the boundary surface between the first clear region 182 and the second clear region 184 being non-parallel to the normal direction of the surface of the three-dimensional object 50, this means that, for example, the normal direction is non-parallel at most of the portions of the boundary surface in a range where the optical action by the prism region 160 is obtained. Thus, for example, a case in which a curved boundary surface is formed, different from the case shown in the figure, and the like, may include a case in which the normal direction is exceptionally parallel at one part of the curved portion, and the like. Furthermore, consideration may be made that the boundary surface between the first clear region 182 and the second clear region 184 is, for example, non-parallel to the surface of the three-dimensional object 50.

According to the present variant, for example, the prism region 160 can be caused to optically function as a prism by forming the first clear region 182 and the second clear region 184 as described above. In this case, causing the prism region 160 to optically function as a prism means, for example, refracting or dispersing light in the prism region 160. The optical function of the prism region 160 in the present variant can be considered as, for example, modulating the light in a path of light in which the light incident from the outside of the three-dimensional object 50 through the coloring region 156 is reflected by the light reflecting region 154, and exits to the outside of the three-dimensional object 50.

According to the present variant, for example, the light is not only reflected by the light reflecting region 154 on the inner side of the coloring region 156, but also can be reflected to variously change the visual effects in the three-dimensional object 50. Thus, for example, a broader range of coloring can be carried out on the three-dimensional object 50. More specifically, it is considered to reflect the light in a shiny state, and the like, for example, by disposing the prism region 160. Furthermore, it is considered to enhance the reflectiveness of the light, and the like by disposing the prism region 160.

The specific configuration of the prism region 160 is not limited to the configuration shown in FIG. 5B, and it is also considered to variously change the configuration. FIG. 5C shows a variant of a configuration of the prism region 160. In this case as well, for example, the prism region 160 can be caused to optically function as a prism by changing the boundary surface between the first clear region 182 and the second clear region 184 in a wavelike form. Thus, a broader range of coloring can be carried out on the three-dimensional object 50. In addition to the above, it is considered to use various configurations including the first clear region 182 and the second clear region 184 for the specific configuration of the prism region 160.

As described above, in the present variant, the first clear region 182 is formed with the clear ink ejected from the inkjet head 202t1, and the second clear region 184 is formed with the clear ink ejected from the inkjet head 202t2. However, in a further variant of the configuration of the prism region 160, the first clear region 182 and the second clear region 184 may be formed by combining a plurality of clear inks. In this case, for example, it is considered to make different the index of refraction, and the like between the first clear region 182 and the second clear region 184 by making different the content ratio of each clear ink. In this case, each of the first clear region 182 and the second clear region 184 is formed with a plurality of types of clear ink combined at a different ratio. Furthermore, in this case, the combination of a plurality of types of clear ink configuring the first clear region 182 may be considered as a first clear material, and the combination of a plurality of types of clear ink configuring the second clear region 184 may be considered as a second clear material.

Furthermore, the first clear region 182 and the second clear region 184 may be considered as being formed as regions of at least a size greater than or equal to an extent that an optical effect necessary in the prism region 160 is obtained. More specifically, the first clear region 182 and the second clear region 182 are preferably regions of a size distinguishable by human eyesight.

In the description made above, the configuration of when forming the prism region 160 between the light reflecting region 154 and the coloring region 156 has been described. According to such configuration, for example, the prism region 160 may also function as a separation region for separating the light reflecting region 154 and the coloring region 156.

Furthermore, it is also considered to form the prism region 160 at, for example, a position other than between the light reflecting region 154 and the coloring region 156. More specifically, for example, it is also considered to form the prism region 160 on the outer side of the coloring region 156. When configured in such a manner as well, a broader range of coloring can be carried out on the three-dimensional object 50. In this case, a translucent region having the functions of the protective region 158 and the prism region 160 may be formed.

In the description made above, the configuration for carrying out more appropriate coloring or a broader range of coloring on the three-dimensional object 50 has been described mainly focusing on the configuration of the three-dimensional object 50. However, in order to more appropriately carry out the coloring on the three-dimensional object 50, for example, it is considered to change the process of color conversion performed at the time of generating the slice data in the control PC 14 (see FIG. 1A).

More specifically, as described above in relation to FIGS. 1A to 1C, at the time of generating the slice data, for example, the slice data is generated based on the 3D data of a general format. Furthermore, in this case, the color conversion to a CMYK color coordinate system is carried out for the color represented with the RGB color coordinate system in the 3D data. In such color conversion, the color of the RGB color coordinate system is once converted to the color of the Lab color coordinate system using a profile in which the color of the RGB color coordinate system and the color of the Lab color coordinate system are associated with each other through, for example, a known method. With respect to the color of the Lab color coordinate system after the conversion, the conversion to the color of the CMYK color coordinate system is further carried out using, for example, a profile in which the color of the Lab color coordinate system and the color of the CMYK color coordinate system are associated with each other.

However, when attempting to carry out the coloring of the three-dimensional object 50 with higher color reproducibility, for example, it is considered to carry out the color conversion through a method different from the known method, and the like. In this case, more specifically, it is considered to carry out the color conversion, and the like focusing on the saturation of the color for coloring on the three-dimensional object 50.

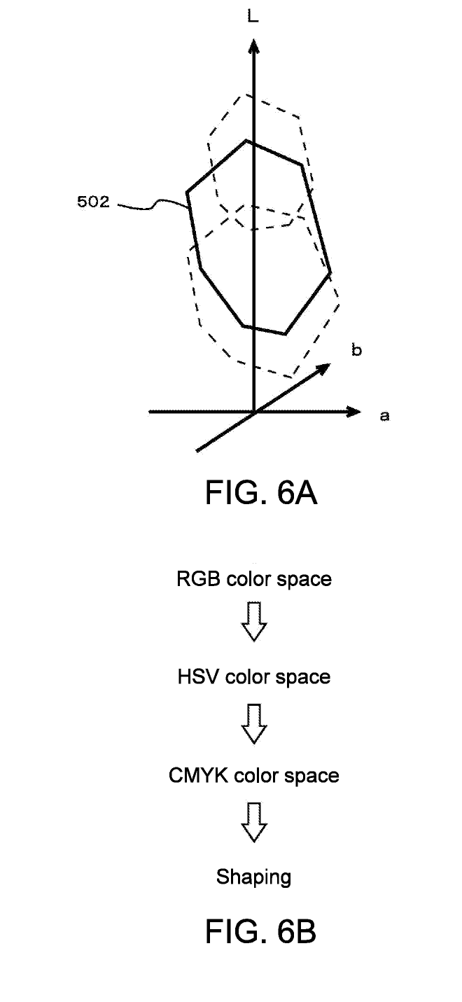

FIGS. 6A and 6B are views describing a variant of the color conversion carried out in the control PC 14. FIG. 6A is a view describing one example of a gamut 502, which is a range of colors that can be represented when shaping the three-dimensional object 50 with the shaping device 12, and shows one example of the gamut 502 in the Lab color coordinate system in a simplified manner. As described above, when shaping the three-dimensional object 50 with the shaping device 12, the coloring on the surface of the three-dimensional object 50 is carried out by forming the light reflecting region 154, the coloring region 156, and the like (see FIG. 2A). In this case, the range of representable colors changes by, for example, the thickness of the coloring region 156, and the like.

More specifically, for example, when the thickness of the coloring region 156 is made thin, a brighter color can be represented. However, in this case, the range of representable color usually becomes narrow compared to when forming a thicker coloring region 156. In this case, the range of representable colors is a range of the gamut 502 within a plane orthogonal to an L axis in the figure. Furthermore, when the thickness of the coloring region 156 is made thick, the range of representable colors becomes wide. However, in this case, a bright color becomes difficult to represent compared to when forming a thinner coloring region 156.

Thus, the range of the gamut 502 at the time of the shaping of the three-dimensional object 50 variously changes depending on the thickness, and the like of the coloring region 156. For example, in the case shown in the figure, when the thickness of the coloring region 156 is made thinner, the gamut becomes a range shown with a broken line on the upper side of the gamut 502 shown with a solid line. Furthermore, when the thickness of the coloring region 156 is made thicker, for example, the gamut becomes a range shown with a broken line on the lower side of the gamut 502 shown with a solid line.

In this case, for example, in the color conversion carried out in the control PC 14, if only a constant conversion set in advance is carried out, the range of colors that can be represented with high color reproducibility and brightness in the three-dimensional object 50 may be limited. On the contrary, in the control PC 14, in order to carry out the color conversion at a higher accuracy, for example, it is considered to carry out the color conversion based on an individual parameter for every three-dimensional object 50 in view of the color to actually color the three-dimensional object 50. In this case, for example, it is considered to carry out the color conversion, and the like focusing on the saturation of the color for coloring the three-dimensional object 50.

More specifically, for example, when carrying out the coloring with a light color on the three-dimensional object 50, and the like, the saturation of the color that can be represented by the coloring region 156 becomes higher as the coloring region 156 becomes thinner. In this case, the coloring region 156 having a thickness more appropriate with respect to the saturation of the color to represent can be formed by, for example, setting the thickness of the coloring region 156 using the saturation of the color to represent as the parameter. Furthermore, in this case, a color reproducible range can be made sufficiently wide and an appropriate color conversion can be carried out for the color conversion in the control PC 14 by carrying out the color conversion while taking into consideration the gamut 502 determined according to the thickness of the coloring region 156.

FIG. 6B shows one example of a color conversion carried out in view of the saturation. In this case, for example, the color conversion from the RGB color space to the HSV color space, and the color conversion from the HSV color space to the CMYK color space are carried out. Furthermore, the slice data is generated with such color conversions carried out to perform, and the shaping of the three-dimensional object 50 is carried out. In this case, the color conversion from the RGB color space to the HSV color space means, for example, carrying out the color conversion to the color of the HSV color coordinate system for the color indicated with the RGB color coordinate system in the 3D data indicating the three-dimensional object 50 to shape. Furthermore, the color conversion from the HSV color space to the CMYK color space means, for example, carrying out the color conversion to the color of the CMYK color coordinate system for the color indicated with the HSV color coordinate system.

In this case, for example, the thickness of the coloring region 156 is determined at the time of the color conversion to the color of the HSV color coordinate system. In this case, the thickness of the coloring region 156 is the thickness of the coloring region 156 in the normal direction of the three-dimensional object 50. According to such configuration, for example, the thickness of the coloring region 156 can be appropriately set to a thickness corresponding to the saturation of the color to represent with the coloring region 156.

Moreover, at the time of the color conversion to the color of the CMYK color coordinate system, the color conversion is carried out while taking into consideration the thickness of the coloring region 156. Furthermore, in this case, the slice data generated in the control PC 14 indicates, for example, a cross-section including the coloring region 156 having the thickness corresponding to the saturation. According to such configuration, for example, the color conversion that takes into consideration the saturation can be appropriately carried out for the color conversion in the control PC 14. Moreover, the coloring with high color reproducibility thus can be appropriately carried out with respect to the three-dimensional object 50.

In FIGS. 6A and 6B, for the sake of convenience of illustration and explanation, with regards to the color conversion carried out in the control PC 14, the color conversion from the RGB color space to the HSV color space and the color conversion from the HSV color space to the CMYK color space are illustrated in such a way as to directly carry out the color conversion. However, in the actual operation of the control PC 14, the color conversion from the RGB color space to the HSV color space and the color conversion from the HSV color space to the CMYK color space may be carried out with, for example, the Lab color coordinate system in between.

As described above, at the time of the shaping of the three-dimensional object 50, the coloring region 156 is formed using, for example, the ink of each color of YMCK and the clear ink. However, in this case, the clear ink is usually not a completely colorless transparent, and has a ground color of a certain extent such as, for example, light yellow. Thus, for example, when the thick coloring region 156 is formed, shift and the like may occur in the color of the coloring region 156 by the influence of the ground color of the clear ink, and the like. In view of such a point, the coloring region 156 can be said as being preferably formed as thin as possible. Thus, for the configuration for carrying out the color conversion in view of the saturation as described above, for example, a configuration of having the thickness of the coloring region 156 as thin as possible by setting the thickness of the coloring region 156 in view of the required saturation, and the like can also be considered.

Furthermore, in a further variant of the color conversion carried out in the control PC 14, it is also considered to, for example, carry out the color conversion based on a parameter other than the saturation. More specifically, for example, it is considered to carry out the color conversion focusing on the brightness of the color to represent and using the brightness as the parameter. Furthermore, it is considered to carry out the color conversion focusing on the hue of the color to represent and using the hue as the parameter. More specifically, in this case, for example, it is considered to change the thickness of the coloring region 156, and the like in accordance with the hue to represent. In this case, for example, it is considered to have the coloring region 156 thick when representing a reddish color, and have the coloring region 156 thin when representing an yellowish color, and the like. Furthermore, in this case, for example, the thickness of the coloring region 156 may be differed depending on the position according to the difference in the color for coloring each position of the three-dimensional object 50.

Next, a supplementary explanation associated with shaping the three-dimensional object 50 with the shaping device 12 will be described. When shaping the three-dimensional object 50 with the shaping device 12, a three-dimensional object having a configuration that can be shaped in a shorter time is sometimes shaped as a proof, or a three-dimensional object for checking, before shaping the actual three-dimensional object 50. In this case, for example, it is considered to shape the proof of a shape in which the three-dimensional object 50 to shape is scale-reduced, and the like.

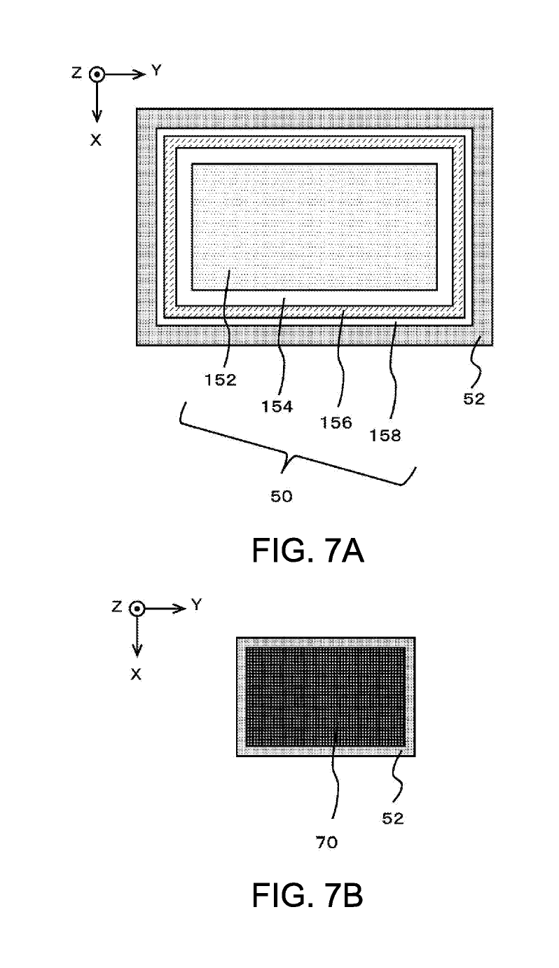

FIGS. 7A and 7B are views for making an explanation in relation to the shaping of a proof 70. FIG. 7A is a view showing one example of a configuration of the three-dimensional object 50 to shape as a final product, and shows the X-Y cross-section of the three-dimensional object 50 same as that shown in FIG. 2A along with the support layer 52. FIG. 7B shows one example of a configuration of the X-Y cross-section of the proof 70 in which the three-dimensional object 50 shown in FIG. 7A is scale-reduced along with the support layer 52.

As described above, when shaping the three-dimensional object 50 whose surface is colored, for example, the three-dimensional object 50 including the light reflecting region 154, the coloring region 156, and the like is shaped. When a truer proof 70 is desirably shaped in relation to the above, for example, it is considered to shape the proof 70 performed with the coloring same as the three-dimensional object 50 even at the time of shaping of the proof 70.

However, at the time of shaping of the proof 70, for example, it is sometimes desirable to shape the proof 70 in a shorter time. Furthermore, for example, when shaping the scale-reduced proof 70, the way that the color is seen sometimes changes by the setting of the thickness of the region corresponding to the light reflecting region 154 and the coloring region 156. Thus, in this case, even if the colored proof 70 is shaped, the color of the three-dimensional object 50 may not be appropriately predicted. Moreover, when shaping the proof 70 of the same size, that is, not scale-reduced, the time required to shape the proof 70 may greatly increase if the proof 70 is shaped with the coloring performed.

Thus, when shaping the proof 70, for example, it is sometimes preferable to shape the proof 70 without taking into consideration the color for coloring the three-dimensional object 50. In this case, it is considered to form the entire proof 70 with, for example, a plurality of inkjet heads 202y to 202k (see FIG. 1C). In this case, forming the entire proof 70 with the plurality of inkjet heads 202y to 202k, and the like means forming the entire proof 70 including the interior thereof, and the like by ejecting the ink of each color of YMCK, and the like from the plurality of inkjet heads 202y to 202k, and the like. According to such configuration, for example, the proof 70 can be shaped at a higher speed compared to, for example, when forming the interior of the proof 70 using only the inkjet head 202mo (see FIG. 1C) for the shaping material ink (Mo ink).

In this case, for example, it is considered to carry out the shaping of the proof 70 using an arbitrary inkjet head other than the inkjet head 202s (see FIG. 1C) for the material of the support layer 52. Furthermore, in this case, for example, it is also considered to shape the proof 70 with only the inkjet head, which usage amount of the ink is small at the time of shaping of the three-dimensional object 50. More specifically, in this case, for example, it is considered to shape the proof 70 using only the inkjet heads 202y to 202k, which are inkjet heads for coloring, and the like. According to such configuration, for example, the usage amount of the ink in each inkjet head can be made more uniform in the entire operation of shaping the proof 70 and the three-dimensional object 50.

Moreover, the operation of shaping the proof 70 using the inkjet heads 202y to 202k, and the like is not limited to the time of shaping of the scale-reduced proof 70, and can be considered to be carried out even when shaping the proof 70 of the same size as the three-dimensional object 50. In this case as well, the shaping of the proof 70 can be carried out at a higher speed by forming the proof 70 using a great number of inkjet heads such as the inkjet heads 202y to 202k.

### INDUSTRIAL APPLICABILITY

The present disclosure can be suitably used in, for example, a shaping device.

What is claimed is:

1. A shaping device that shapes a stereoscopic three-dimensional object, the shaping device comprising:
a light reflecting material head, which is an ejection head that ejects a material having light reflectiveness;
a plurality of coloring material heads, which are a plurality of ejection heads that respectively ejects a coloring material of a color different from each other;
a clear material head, which is an ejection head that ejects a clear material or a translucent material that is not colored; and
a controller that controls operations of the light reflecting material head, the plurality of coloring material heads, and the clear material head, wherein
the three-dimensional object includes
a light reflecting region, which is a region having light reflectiveness, formed using the material having light reflectiveness, and
a coloring region, which is a region formed on an outer side than the light reflecting region using the coloring material and the clear material;
the coloring region includes
an inner region, which is a region closer to the light reflecting region, and
an outer region, which is a region formed on an outer side than the inner region; and
when a ratio of an amount of the coloring material with respect to a sum of an amount of materials for shaping used when forming each region of the coloring region is defined as a coloring material ratio, the controller causes the plurality of coloring material heads and the clear material head to eject a material for shaping so that the coloring material ratio in the outer region becomes greater than the coloring material ratio in the inner region.

2. The shaping device according to claim 1, wherein during forming the coloring region, the controller causes the clear material head and the plurality of coloring material heads to form the coloring region so that an arrangement of the coloring material and the clear material in the coloring region is lined with the clear material on an inner side and the coloring material on an outer side on a straight line from the light reflecting region toward the outer side of the three-dimensional object.

3. The shaping device according to claim 1, wherein the three-dimensional object further includes an outer clear region, which is a region formed on an outer side of the coloring region using the clear material.

4. A shaping device that shapes a stereoscopic three-dimensional object, the shaping device comprising:
a light reflecting material head, which is an ejection head that ejects a material having light reflectiveness;
a coloring material head, which is an ejection head that ejects a coloring material; and
a controller that controls operations of the light reflecting material head and the coloring material head, wherein
the three-dimensional object includes
a light reflecting region, which is a region having light reflectiveness formed using the material having light reflectiveness, and
a coloring region, which is a region formed on an outer side than the light reflecting region using the coloring material; and
the light reflecting material head ejects a material having glossiness as the material having light reflectiveness.

5. The shaping device according to claim 4, wherein the material having light reflectiveness is an ink containing a pigment having glossiness.

6. The shaping device according to claim 4, wherein during forming the light reflecting region, the controller causes the coloring material head to eject the coloring material and causes the light reflecting material head to eject the material having glossiness to cause the coloring material head and the light reflecting material head to form a colored light reflecting region having glossiness.

7. A shaping device that shapes a stereoscopic three-dimensional object, the shaping device comprising:
a light reflecting material head, which is an ejection head that ejects a material having light reflectiveness;
a coloring material head, which is an ejection head that ejects a coloring material; and
a controller that controls operations of the light reflecting material head and the coloring material head, wherein
the three-dimensional object includes
a light reflecting region, which is a region having light reflectiveness, and
a coloring region, which is a region formed on an outer side than the light reflecting region using the coloring material; and
the controller causes the light reflecting material head to eject the material having light reflectiveness and causes the coloring material head to eject the coloring material to cause the light reflecting material head and the coloring material head to form the light reflecting region in which at least one part is colored with the coloring material.

8. The shaping device according to claim 7, wherein the controller causes the coloring material head to eject the coloring material to at least one part of the light reflecting region to match a color represented by overlapping the coloring region and the light reflecting region with a color to be colored on the three-dimensional object.

9. The shaping device according to claim 7, wherein the controller causes the coloring material head to color only one part of the light reflecting region with the coloring material; and
the one part of the light reflecting region is a region corresponding to a portion where a density of a color to be colored on a surface of the three-dimensional object is darker than a density set in advance.

10. A shaping device that shapes a stereoscopic three-dimensional object, the shaping device comprising:
a light reflecting material head, which is an ejection head that ejects a material having light reflectiveness;
a coloring material head, which is an ejection head that ejects a coloring material;
a plurality of clear material heads, which are a plurality of ejection heads that respectively ejects a clear material or a translucent material that is not colored; and
a controller that controls operations of the light reflecting material head, the coloring material head, and the plurality of clear material heads, wherein
each of the plurality of clear material heads ejects the clear material having a different transmission characteristic with respect to light;
the three-dimensional object includes
a light reflecting region, which is a region having light reflectiveness, formed using the material having light reflectiveness,
a translucent region, which is a region formed on an outer side than the light reflecting region using a plurality of types of clear material ejected from each of the plurality of clear material heads, and
a coloring region, which is a region formed on an outer side than the light reflecting region using the coloring material; and
the translucent region includes
a first clear region formed with a first clear material, and
a second clear region formed with a second clear material different from the first clear material.

11. The shaping device according to claim 10, wherein the translucent region is formed between the light reflecting region and the coloring region so that light is modulated in a path of light in which light incident from outside of the three-dimensional object through the coloring region is reflected by the light reflecting region and exits to the outside of the three-dimensional object.

12. The shaping device according to claim 10, wherein a normal direction of a boundary surface between the first clear region and the second clear region is non-parallel to a normal direction of a surface of the three-dimensional object on an outer side of the boundary surface.

13. The shaping device according to claim 10, wherein the first clear region is formed on a light reflecting region side of the translucent region;
the second clear region is formed on an outer side of the first clear region while making contact with the first clear region; and
a boundary surface between the first clear region and the second clear region is a wave-like surface where a distance from a surface of the three-dimensional object changes depending on position.

14. The shaping device according to claims 10, wherein the translucent region includes the first clear region and the second clear region; and
light is refracted or dispersed in the translucent region.

15. A shaping device that shapes a stereoscopic three-dimensional object, the shaping device comprising:
a light reflecting material head, which is an ejection head that ejects a material having light reflectiveness;
a coloring material head, which is an ejection head that ejects a coloring material; and
a controller that controls operations of the light reflecting material head and flue coloring material head, wherein
the three-dimensional object includes
a light reflecting region, which is a region having light reflectiveness formed using the material having light reflectiveness, and
a coloring region, which is a region formed on an outer side than the light reflecting region using the coloring material; and
a thickness of the coloring region in a normal direction of the three-dimensional object is set to a thickness corresponding to a saturation of a color to represent in the coloring region.

16. The shaping device according to claim 15, wherein the shaping device shapes the three-dimensional object based on slice data, which is data indicating a cross-section of the three-dimensional object to shape; and
the slice data indicates the cross-section including the coloring region having a thickness corresponding to the saturation.

17. A shaping method for shaping a stereoscopic three-dimensional object, comprising
a step of shaping the three-dimensional object using the shaping device according to claim 1.

18. A shaping method for shaping a stereoscopic three-dimensional object, comprising
a step of shaping the three-dimensional object using the shaping device according to claim 4.

19. A shaping method for shaping a stereoscopic three-dimensional object, comprising
a step of shaping the three-dimensional object using the shaping device according to claim 7.

20. A shaping method for shaping a stereoscopic three-dimensional object, comprising
a step of shaping the three-dimensional object using the shaping device according to claim 10.

21. A shaping method for shaping a stereoscopic three-dimensional object, comprising
a step of shaping the three-dimensional object using the shaping device according to claim 15.
